(19) United States
(12) Patent Application Publication
(10) Pub. No.: US 2019/0066188 A1
(43) Pub. Date: Feb. 28, 2019

(54) System and Method of Assisting a User in Automated Buying from a Retail Store

(71) Applicant: Leigh M. Rothschild, Miami, FL (US)

(72) Inventor: Leigh M. Rothschild, Miami, FL (US)

(21) Appl. No.: 16/111,361

(22) Filed: Aug. 24, 2018

Related U.S. Application Data
(60) Provisional application No. 62/549,461, filed on Aug. 24, 2017.

(51) Int. Cl. G06Q 30/06; G06Q 20/40

(52) U.S. Cl. CPC G06Q 30/0633; G06Q 20/40145

(57) ABSTRACT

A device, system, and a method of assisting a user in automated buying from a retail store are disclosed. The method comprises detecting presence of a user into the retail store. Presence of items of user's interest in the retail store may be identified. Upon identifying, the user may add the items in an online shopping cart. The user may be authenticated, using his biometric details, for making an online payment of the items. Upon payment, an item bill and a payment receipt may be generated towards the online payment. Thereafter, the user may be allowed to carry the items from the retail store based on matching of details of the item bill with the items carried by the user.

### PRIORITY

This patent application claims the benefit of U.S. Provisional Application No. 62/549,461, filed on Aug. 24, 2017.

### FIELD OF THE DISCLOSURE

The present disclosure is generally related to making purchases in retail stores, and more particularly related to automated purchase of items in the retail stores.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Buying items from a retail store is a cumbersome task. The items may refer to any product or object of small, medium, or large size. A user himself needs to identify availability of a required item and subsequently locate the item. A retail store is vast in size and it takes a lot of time to reach every corner and locate each item. Currently, the user does not get to know about price of the item in other stores. Further, the user is also not able to negotiate on the price of each item available in the retail store.

Upon finding the items, each item needs to be carried in a cart or trolley to a payment counter. At the payment counter, each item is counted and billed separately, which again consumes a lot of time. After a bill is prepared, the user needs to make payment towards the items bought. Thus, it requires a lot of time and effort at each stage of buying the items from retail stores and an efficient method of buying the items from the retail stores is much desired.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a network connection diagram 100 of a system 102 for assisting a user in automated buying from a retail store, according to an embodiment.

FIG. 2 illustrates a flowchart 200 showing a method of assisting a user in automated buying from a retail store, according to an embodiment.

FIG. 3 illustrates a flowchart 300 showing a method of assisting a user in automated buying from a retail store, according to another embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

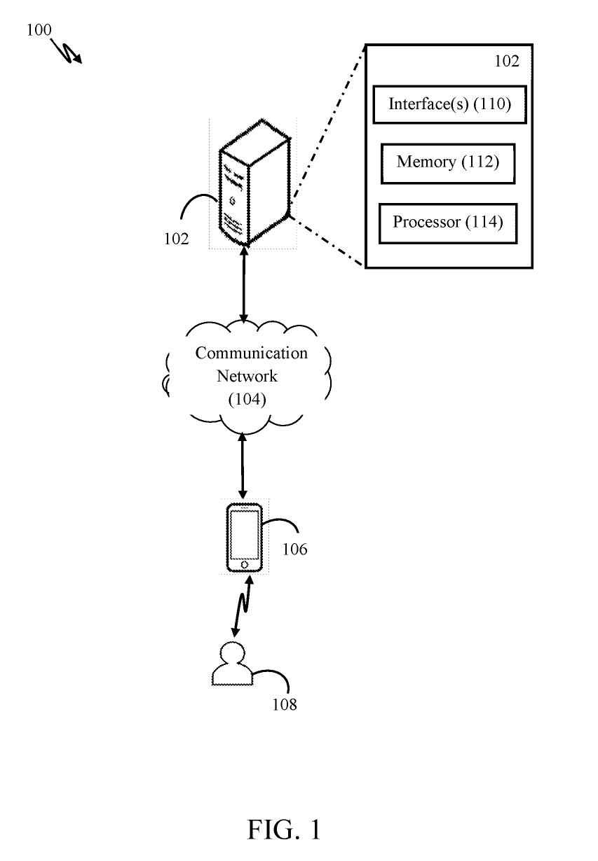

FIG. 1 illustrates a network connection diagram 100 of a system 102 for assisting a user in automated buying from a retail store, according to an embodiment. The system 102 may be connected to a communication network 104. The communication network 104 may further be connected with a user device 106, operated by a user 108. The user device 106 is shown to be a smart phone, however, other devices such as a tablet, phablet, and laptop may also be used.

The communication network 104 may be a wired and/or a wireless network. The communication network 104, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

The system 102 is shown to comprise interface(s) 110, a memory 112, and a processor 114. The interface(s) 110 may be used by the user to program the system 102. The interface(s) 110 of the system 102 may either accept an input from the user or provide an output to the user, or may perform both the actions. The interface(s) 110 may either be a Command Line Interface (CLI), Graphical User Interface (GUI), or a voice interface.

The memory 112 may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The processor 114 may execute an algorithm stored in the memory 112 for assisting a user in automated buying from a retail store. The processor 114 may also be configured to decode and execute any instructions received from one or more other electronic devices or server(s). The processor 206 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The processor 114 may be configured to execute one or more computer-readable program instructions, such as program instructions to carry out any of the functions described in this description.

In an embodiment, a user 108 entering into a retail store may be detected. In one case, the user 108 may be detected by a Global Positioning System (GPS) device. The GPS device present in a user device 106 may be used in one case, to determine a current location of the user 108. From the current location of the user 108, it may be determined that the user 108 is currently present in the retail store. A geo-location of the user 108 may be stored along with a time-stamp, while the user 108 is entering the retail store. Alternatively, the user 108 may use a mobile application installed on the user device 106 for shopping from retail stores, and may indicate his presence in the retail store using the mobile application. Further, entry of the user into the retail store may also be determined using other techniques, such as Near Field Communication (NFC), Bluetooth, and Wireless Fidelity (Wi-Fi). For example, while the user device 106 is discoverable via NFC, Bluetooth, or Wi-Fi, entry of the user into the retail store may be determined.

In an embodiment, a photograph of the user 108 may be captured while the user 108 enters the retail store. The photograph may be captured using a Closed Circuit Television (CCTV) camera connected to the system 102. Further, the photograph may also be captured as a selfie by the user 108 using the user device 106. In one case, the photograph of the user may be pre-stored in a memory of the user device 106. The user device 106 may transmit the photograph to the system 102, while the user 108 enters into the retail store. The photograph may be used for determining a time of entry of the user 108 into the retail store and items carried by the user 108 from outside to the retail store.

Successively, presence of items of user's interest, in the retail store, may be identified. In one case, the user 108 may select the items of his interest through the mobile application. The items may then be searched in the system 102 for identifying their presence in the retail store. The system 102 may store details of all items available in the retail store, and may identify the items searched by the user 108.

In one embodiment, the user 108 may capture a picture, using the user device 106, of an item present in the retail store. Further, the image of the item may be pre-stored in the memory of the user device 106. The user device 106 may send the image of the item to the system 102. Upon receiving, the system 102 may identify the item from the image, and may add the item to user's shopping cart. In another case, a symbology (such as barcode) associated with the item or an identifier (such as a Radio Frequency Identification Tag (RFID) tag) associated with the item may be scanned to identify the item, and the item may be added to the user's shopping cart.

In one embodiment, the user 108 may use mobile application installed on the user device 106 for indicating items or categories of items of interest. Such information related to the items or categories of items may be sent to the system 102. A retailer may analyse such information received through the system 102, and may make recommendations to the user 108 based on analysis of the information. The recommendations may comprise information about related items, offers related to the items including coupons, and availability of the items.

Upon identifying presence of the items, the user 108 may add the items in the online shopping cart. The user 108 may use the mobile application for providing a user input to add the items in the online shopping cart. Further, the user 108 may be notified about items available on sale, in the retail store. In one case, the user 108 may be notified through the mobile application running on the user device 106. Coupon codes for availing discount on the items may be sent on the user device 106, in one case.

In one embodiment, the user 108 may be guided to physical locations, in the retail store, comprising the items of user's interest. In one case, the user 108 may be guided through the user device 106. The user 108 upon reaching the physical locations may add the items in a physical cart, as he adds the items in the online shopping cart.

In one embodiment, the user 108 may process details of the items to perform multiple operations. For example, the user 108 may receive information about the items, post the information about the items on a social networking platform, send the information about the items on a user mail, add the items to a user wishlist, add the items to a user cart for buying, determine a total cost of the items present in the user cart, and compare current prices of the items with prices offered by other retail stores.

In one embodiment, the user 108 may receive information about the items in at least one format of text, hyperlink, video, and audio. In one case, the user 108 may receive the information about an item as a hyperlink. Upon clicking the hyperlink, the user 108 may be directed to a web page providing information about the item. In another case, the user 108 may receive information about the product as a video. The video may comprise all details, such as features, price, and discount related to the item.

In one embodiment, using the mobile application, the user 108 may send an alternative price of a concerned item. The alternative price may be different from the proposed price of the concerned item, present in the retail store. Based on a received alternate price, the system 102 may make a counter offer to the user 108 i.e. the system 102 may communicate a final price for selling the concerned item. Based on such negotiation, the user 108 may select or reject to buy each item. In one case, such negotiations may be made by a retailer or an operator handling the system 102. Further, details of performing such negotiations may be automated at the system 102, and the system 102 may automatically communicate with the user 108 to settle on a price of the concerned item.

Once the user 108 has selected all items for buying, the user 108 may need to make online payment of the items. In one case, the online payment could be made using the mobile application. The mobile application may interact with a payment portal for enabling the user 108 to make the online payment. The mobile application may authenticate the user 108 before accessing the payment portal. The authentication may be performed using biometric details of the user 108. In one case, the biometric details may be any of retina scan, fingerprint, finger vein patterns, face scan, voice, Electrocardiogram (ECG) wave, Electroencephalogram (EEG) wave, and Deoxyribonucleic Acid (DNA), of the user 108. For example, the user 108 may get authenticated through the face scan technique.

Post successful authentication, the user 108 may be allowed to make the online payment. In one case, the online payment may be automatically made using pre-stored financial credentials of the user 108. The financial credential of the user 108 could be stored in the mobile application or may be store over a cloud network. Upon making the online payment, an item bill and a payment receipt may be generated towards the online payment. In one case, the item bill and the payment receipt may be stored over the cloud network, for future references.

In one embodiment, a copy of the item bill may be sent to the retailer or the operator monitoring exit of the items from the retail store. The details of the item bill may be matched with the items carried by the user 108, in one case. The user 108 may be carrying the items in the physical cart. Further, the user 108 may be identified from the photograph sent to the retailer, in another case. Based on at least one of successful matching and successful identification, the user 108 may be allowed to carry the items from the retail store. Using the photograph of the user 108 may help in avoidance incidents, such as shoplifting and missed payment of item(s) by the user 108.

In one embodiment, purchase details of the items may be sent to respective manufacturers, for securing warranty registration of the items. In one case, the purchase details may be sent through the mobile application. Details of the items may comprise specifications and quantities of each item, and such details may be used for warranty registration of the items bought by the user 108. For example, the user 108 may buy two Philips™ tube lights on Aug. 1, 2017. The tube lights may be available with a warranty of three years. In such case, the purchase details present in the item bill i.e. date of purchase of item(s), type of item(s), and quantities of item(s) may automatically be fetched and may be used for preparing warranty registration cards for the user 108. Further, the user device 106 may automatically send user's personal details, such as identity of the user 108, address, e-mail address, and phone number of the user 108, to a web address for preparing the warranty registration cards for the user 108.

Thus, the user 108 may conveniently shop the items available in the retail store using the present system 102. The user 108 may merely need to interact with the mobile application for buying items of his choice.

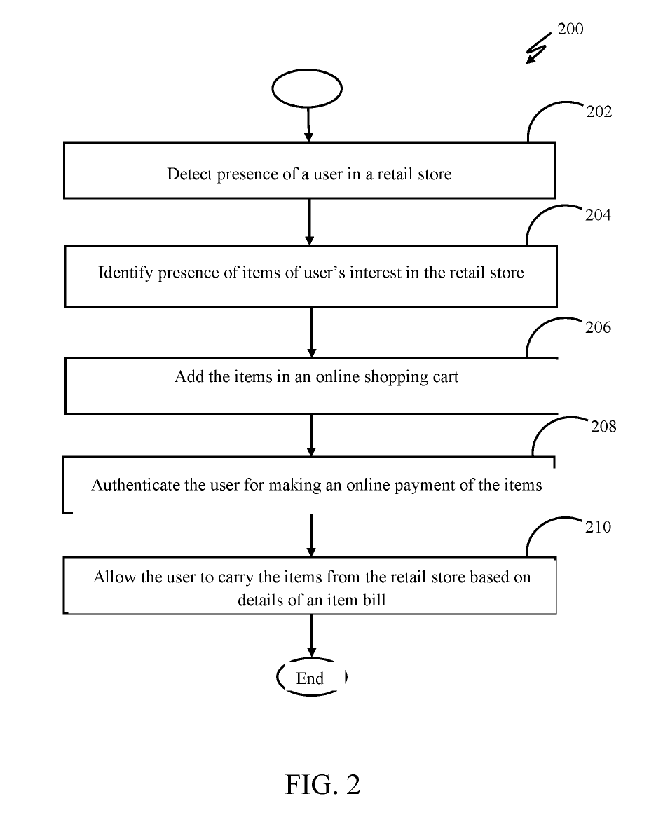

FIG. 2 illustrates a flowchart 200 of a method of assisting a user 108 in automated buying from a retail store. FIG. 2 comprises a flowchart 200 that is explained in conjunction with the elements disclosed in FIG. 1, explained above.

The flowchart 200 of FIG. 2 shows the architecture, functionality, and operation for assisting a user 108 in automated buying from a retail store. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 200 starts at the step 202 and proceeds to step 210.

At step 202, presence of the user 108 into a retail store may be determined. Presence of the user 108 into the retail store may be determined using a Global Positioning System (GPS) device, in an embodiment. The user 108 may indicate his presence in the retail store using a mobile application installed of a user device 106, in another embodiment.

At step 204, presence of items of user's interest in the retail store may be identified. Presence of the items may be identified by a system 102 and may be intimated to the user 108 through the mobile application, in an embodiment.

At step 206, the items may be added in an online shopping cart by the user 108. In one case, the user 108 may capture a picture, using the user device 106, of an item present in the retail store. Further, the image of the item may be pre-stored in the memory of the user device 106. The user device 106 may send the image of the item to the system 102. Upon receiving, the system 102 may identify the item from the image, and may add the item to the online shopping cart. In another case, a symbology (such as barcode) associated with the item or an identifier (such as a Radio Frequency Identification Tag (RFID) tag) associated with the item may be scanned to identify the item, and the item may be added to the online shopping cart. The user 108 may select to add the items using the mobile application, in another case.

At step 208, the user 108 may be authenticated for making an online payment of the items. The user 108 may be authenticated using biometric details of the user 108, in an embodiment.

At step 210, the user 108 may be allowed to carry the items from the retail store. The user 108 may be allowed to carry the items based on matching of details of an item bill with the items carried by the user 108, in an embodiment.

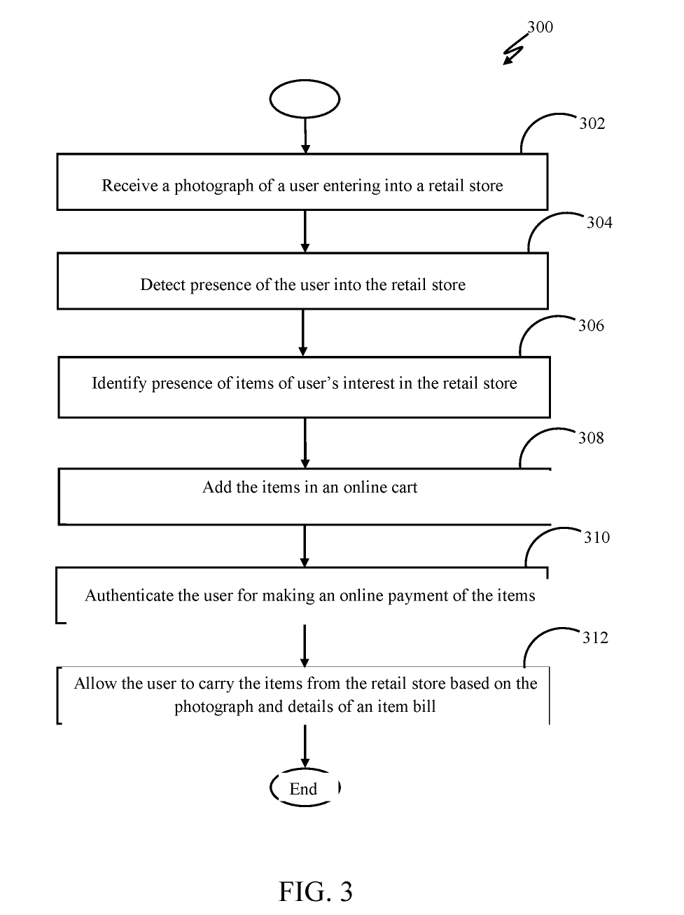

FIG. 3 illustrates a flowchart 300 of a method of assisting a user 108 in automated buying from a retail store. FIG. 3 comprises a flowchart 300 that is explained in conjunction with the elements disclosed in FIG. 1, explained above.

The flowchart 300 of FIG. 3 shows the architecture, functionality, and operation for assisting a user 108 in automated buying from a retail store. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 3 may in fact be executed substantially concurrently or the blocks may sometimes be executed in the reverse order, depending upon the functionality involved. Any process descriptions or blocks in flowcharts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine. The flowchart 300 starts at the step 302 and proceeds to step 312.

At step 302, a photograph of a user 108 entering into a retail store may be received. The photograph may be captured as a selfie, by the user 108, in an embodiment. In one case, the photograph may be pre-stored in a memory of the user device 106 and may be transmitted to the system 102.

At step 304, presence of the user 108 into the retail store may be determined. Presence of the user 108 into the retail store may be determined using a Global Positioning System (GPS) device, in an embodiment. The user 108 may indicate his presence in the retail store using a mobile application installed of a user device 106, in another embodiment.

At step 306, presence of items of user's interest in the retail store may be identified. Presence of the items may be identified by a system 102 and may be intimated to the user 108 through the mobile application, in an embodiment.

At step 308, the items may be added in an online shopping cart by the user 108. The user 108 may use the mobile application to add the items, in one case. In another case, the user 108 may capture a picture, using the user device 106, of an item present in the retail store. Further, the image of the item may be pre-stored in the memory of the user device 106. The user device 106 may send the image of the item to the system 102. Upon receiving, the system 102 may identify the item from the image, and may add the item to online shopping cart. In another case, a symbology (such as barcode) associated with the item or an identifier (such as a Radio Frequency Identification Tag (RFID) tag) associated with the item may be scanned to identify the item, and the item may be added to the online shopping cart.

At step 310, the user 108 may be authenticated for making an online payment of the items. The user 108 may be authenticated using biometric details of the user 108, in an embodiment.

At step 312, the user 108 may be allowed to carry the items from the retail store. The user 108 may be allowed to carry the items based on identification of the user 108 from the photograph and matching of details of the item bill with the items carried by the user 108, in an embodiment.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A method of assisting a user in automated buying from a retail store, the method comprising:
detecting, by a Global Positioning System (GPS) device, presence of the user into the retail store;
identifying, by a processor, presence of items of user's interest, in the retail store;
adding, by the processor, the items in an online shopping cart based on a user input;
authenticating, by the processor, the user for making an online payment of the items, and generating an item bill and a payment receipt towards the online payment; and
allowing, by the processor, the user to carry the items from the retail store based on matching of details of the item bill with the items carried by the user.

2. The method of claim 1, further comprising notifying the user about items available on sale, in the retail store.

3. The method of claim 1, further comprising scanning at least one of a symbology and an identifier, associated with the items, for identifying the item.

4. The method of claim 1, further comprising storing the item bill and the payment receipt over a cloud network.

5. The method of claim 1, further comprising processing details of the items to perform at least one operation selected from a group consisting of receiving information about the items, posting the information about the items on a social networking platform, sending the information about the items on a user mail, adding the items to a user wishlist, adding the items to a user cart for buying, determining a total cost of the items present in the user cart, and comparing current prices of the items with prices offered by other retail stores.

6. The method of claim 4, wherein the information about the items is received in at least one format of text, hyperlink, video, and audio.

7. The method of claim 1, further comprising receiving an alternative price of at least one item from the user, and communicating a final price for sale of the at least one item.

8. The method of claim 1, further comprising guiding the user to physical locations, in the retail store, comprising the items of user's interest.

9. The method of claim 1, wherein the user is authenticated using biometric details of the user.

10. The method of claim 8, wherein the biometric details are selected from a group consisting of retina scan, fingerprint, finger vein patterns, face scan, voice, Electrocardiogram (ECG) wave, Electroencephalogram (EEG) wave, and Deoxyribonucleic Acid (DNA).

11. The method of claim 1, wherein the online payment is made using pre-stored financial credentials of the user.

12. The method of claim 1, further comprising sending a copy of the item bill to a person monitoring exit of the items from the retail store.

13. The method of claim 1, further comprising identifying the user from a photograph of the user captured while entering the retail store.

14. The method of claim 12, wherein the photograph is a selfie captured by the user.

15. The method of claim 1, further comprising sending a pre-stored photograph of the user to a retailer in the retail store for marking an entry of the user into the retail store.

16. The method of claim 1, further comprising sending purchase details of the items to respective manufacturers for securing warranty registration of the items.

17. A system for assisting a user in automated buying from a retail store, the system being configured to:
detect presence of the user into the retail store;
identify presence of items of user's interest, in the retail store;
add the items in an online shopping cart based on a user input;
authenticate the user for making an online payment of the items, and generating an item bill and a payment receipt towards the online payment; and
allow the user to carry the items from the retail store based on matching of details of the item bill with the items carried by the user.

18. A system for assisting a user in automated buying from a retail store, the system being configured to:
receive a photograph of the user entering the retail store;
detect presence of the user into the retail store;
identify presence of items of user's interest, in the retail store;
add the items in an online shopping cart, based on a user input;
authenticate the user for making an online payment of the items, and generating an item bill and a payment receipt towards the online payment; and
allow the user to carry the items from the retail store based on identification of the user from the photograph and matching of details of the item bill with the items carried by the user.
